(19) United States
(12) Patent Application Publication
(10) Pub. No.: US 2014/0084867 A1
(43) Pub. Date: Mar. 27, 2014

(54) SECONDARY BATTERY DEVICE AND BATTERY CAPACITY ESTIMATION SYSTEM

(71) Applicant: KABUSHIKI KAISHA TOSHIBA, Tokyo (JP)

(72) Inventors: Yoshiyuki HAMAOKA, Tokyo (JP); Toshiro Shimada, Tokyo (JP)

(73) Assignee: Kabushiki Kaisha Toshiba, Tokyo (JP)

(21) Appl. No.: 13/777,093

(22) Filed: Feb. 26, 2013

(30) Foreign Application Priority Data
Sep. 24, 2012 (JP) 2012-209392

(51) Int. Cl. H02J 7/02

(52) U.S. Cl. CPC H02J 7/025
USPC 320/116; 320/136

(57) ABSTRACT

Certain embodiments provide a secondary battery device comprising: a battery module including a plurality of secondary battery cells; a battery monitoring circuit that measures a cell voltage value and a cell temperature value of each cell; a current measurement circuit that measures a current value flowing through the battery module; a time addition unit that adds time information to the current value, the cell voltage value and the cell temperature value, respectively; a memory that stores the current value, the cell voltage value and the cell temperature value, each value being associated with time information; and an operation unit that calculates a time difference between the cell temperature value and the cell voltage value, or a time difference between the cell temperature value and the current value stored in the memory, and determines a degree of deterioration for each cell according to the time difference.

### CROSS-REFERENCE TO RELATED APPLICATION

The present application claims priority under 35 U.S.C. 119 to Japanese Patent Application Ser. No. 2012-209392, filed on Sep. 24, 2012, the entire disclosure of which is incorporated herein by reference.

### FIELD

One embodiment relates to a secondary battery device and a battery capacity estimation system.

### BACKGROUND

Lithium ion batteries are used for the power sources for driving motors of electric motorcars or hybrid cars. A brand-new lithium ion battery has a full charge capacity of a value close to 100% of the rated capacity by charging. However, the full charge capacity drops by repetition of charge and discharge.

The full charge capacity means a capacity of a battery accumulable after multiple times of repetition of charge and discharge of the battery. The capacity is a charged capacity. The capacity is expressed by ampere hour (Ah).

A plurality of battery modules are carried in a vehicle. A battery module is modularized with a battery monitoring circuit (which may be hereinafter referred to as the VTM [voltage temperature monitor] circuit) for monitoring the capacity of this battery module. The battery module provides electric power required for a motor drive.

Based on the charge and discharge of a battery, the VTM circuit accumulates the addition of quantity of electricity charged and the subtraction of quantity of electricity discharged, thereby computing an integrated value as a capacity of the battery.

A battery module has a plurality of cells (secondary battery cells). The capacities and temperatures are not equal among the plurality of cells. In use of a lithium ion battery, the VTM circuit measures the cell voltage and cell temperature of each cell and the electric current of the battery module in order to avoid an unusual state of cells, such as an overcharge or overdischarge.

In addition, in order to prevent the cell voltage from reaching the upper limit of charge-voltage and the discharge lower limit voltage, the VTM circuit equalizes the cell voltages among the plurality of cells by cell balance control. The VTM circuit selects the cells having high cell voltage individually, for allowing the cells to discharge intentionally.

### BRIEF DESCRIPTION OF THE DRAWINGS

FIG. 1 is a configuration diagram of a vehicle having a battery capacity estimation system according to one embodiment;

FIG. 2 is a functional block diagram of a secondary battery device according to one embodiment;

FIG. 3 is a diagram illustrating an example of a configuration of a battery monitoring circuit of the secondary battery device according to one embodiment;

FIG. 4 is a diagram illustrating an example of a discharge characteristic of the secondary battery device according to one embodiment;

FIG. 5 is a diagram illustrating types of deterioration patterns subject to management by an operation unit of the secondary battery device according to one embodiment;

FIG. 6 is a diagram illustrating a first evaluation function by the operation unit of the secondary battery device according to one embodiment; and

FIG. 7 is a diagram illustrating a second evaluation function by the operation unit of the secondary battery device according to one embodiment.

### DETAILED DESCRIPTION

In the related art, however, it is not possible to measure a remaining capacity of a battery module with sufficient accuracy because the repetition of charge and discharge causes errors to accumulate in the values of full charge capacity. The actual full charge capacity of the battery module may drop to 80% of the full charge capacity of a new battery module due to deterioration.

For convenience, a battery management unit for capacity estimation displays an integral value of the electric currents of charge and discharge. The battery management unit cannot measure a degree of the actual capacity deterioration of the battery module with sufficient accuracy. The battery management unit cannot predict a lifetime of the battery module.

In measurement of the voltage of a battery, the amount of voltage changes of 50 mV is overlapped to the voltage of 1.5-2.0V (volt). Hence a right measurement value cannot be obtained. Since an AD (analogue to digital) converter naturally has a resolution limitation determined by the number of bits, battery voltage cannot be obtained with high accuracy.

Since each cell voltage is not correctly measurable due to the accumulation of errors into the full charge capacity, the VTM circuit cannot equalize the cell voltages correctly. There exists a case where, among a plurality of cells, a cell of which the voltage reaches an upper limit or a cell of which the voltage reaches a lower limit cannot be identified correctly.

Especially, battery modules for cars discharge large current because a motor acquires a large torque at the time of climbing. Battery modules are used in areas having a large difference of temperatures.

There exists a case where a motor is rotated with high voltage when the temperature is high, or a motor consumes large current when the temperature is low.

Deterioration which is more remarkable than the battery modules for personal computers occurs in the battery modules for cars. In addition to the capacity errors accumulated due to the repetition of charge and discharge, the amount of consumed current and the usage environment widely vary in the battery modules for motors. The degree of deterioration of a battery module cannot be correctly obtained from an integrated value because of the variation.

Certain embodiments provide a secondary battery device comprising: a battery module including a plurality of secondary battery cells; a battery monitoring circuit configured to measure a cell voltage value and a cell temperature value of each of the cells of the battery module; a current measurement circuit configured to measure a current value flowing through the battery module in timing substantially identical to measurement timing by the battery monitoring circuit; a time addition unit configured to add time information to the current value, the cell voltage value and the cell temperature value, respectively; a memory configured to store the current value, the cell voltage value and the cell temperature value, each value being associated with the time information; and an operation unit configured to calculate a time difference between the cell temperature value and the cell voltage value, or a time difference between the cell temperature value and the current value stored in the memory, the operation unit determining a degree of deterioration for each of the cells according to the time difference.

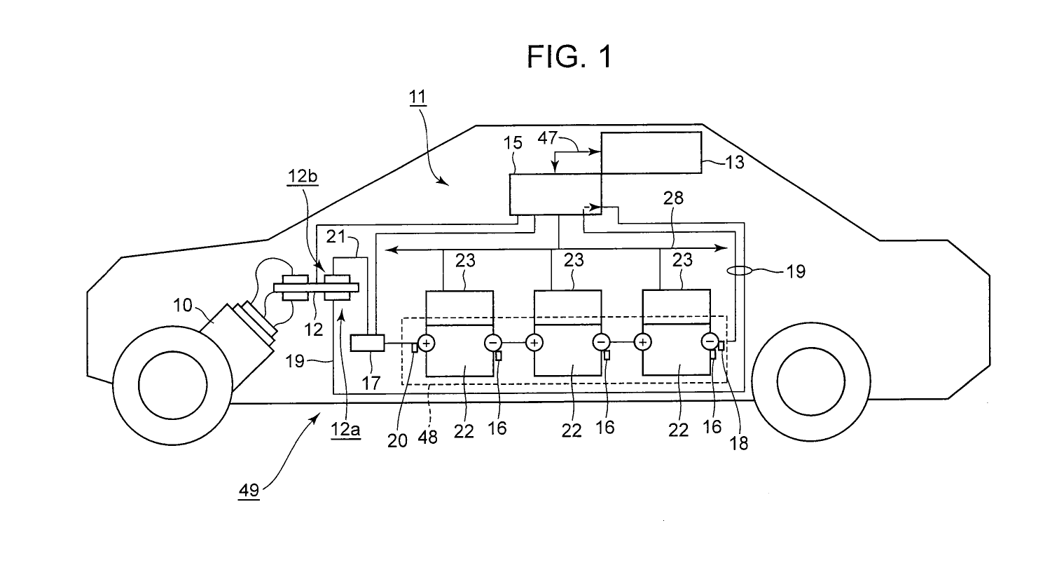

The following will describe a secondary battery device and a battery capacity estimation system according to the embodiments referring to FIG. 1 through FIG. 7. Like reference numerals represent like elements in the drawings, and duplicate explanations are omitted.

FIG. 1 is a configuration diagram of a vehicle having a battery capacity estimation system according to an embodiment.

The battery capacity estimation system according to the present embodiment includes a motor 10 which gives a torque to an axle, and a secondary battery device 11 which is a power source of a drive of the motor 10.

The battery capacity estimation system includes an inverter 12 and an electronic control unit (hereinafter referred to as the ECU [electronic control unit] circuit) 13.

The inverter 12 applies three-phase alternating voltage to the motor 10 from the electric power from the secondary battery device 11. The ECU circuit 13 responds to an operational input by a driver and controls an entire vehicle 49, thereby managing a system as an upper device.

The secondary battery device 11 includes three battery modules 22 in series and a battery management unit (hereinafter referred to as the BMU [battery monitor unit] circuit) 15 which estimates the capacity of each battery module 22 and monitors the necessity of charge and discharge.

In FIG. 1, three battery modules 22 constitute a battery pack 48. The measurement values with the time stamps (measurement history information), of cell voltages, electric currents and temperatures of a plurality of cells included in each battery module 22 are input into the BMU circuit 15. The BMU circuit estimates the capacities according to this measurement history information.

A connecting line 19 is connected to a negative electrode terminal 18 of the battery module 22 at the last stage. This connecting line 19 is turned back at the BMU circuit 15 to be connected to a negative electrode input terminal 12a of an inverter 12.

A connecting line 21 is connected to a positive electrode terminal 20 of the battery module 22 at the front stage via a switch unit 17. This connecting line 21 is connected to a positive electrode input terminal 12b of the inverter 12.

The secondary battery device 11 also includes VTM circuits 23, a plurality of current measurement circuits (hereinafter referred to as the CC [coulomb counter] circuit) 16, and the switch unit 17.

The VTM circuits 23 (battery monitoring circuits) measure respective cell voltage values and respective cell temperature values in units of the battery module 22.

Each of the CC circuits 16 (a current measurement circuit) measures the electric current value flowing through the battery module 22 in timing substantially identical to measurement timing by the VTM circuit 23.

The switch unit 17 switches ON/OFF of the electric power supply between the battery modules 22 and the motor 10.

Specifically, the secondary battery device 11 is constituted by three circuit boards. The secondary battery device 11 includes the VTM circuits 23, CC circuits 16 and the BMU circuit 15.

The CC circuits 16 measure charge quantities in units of the battery pack 48. The BMU circuit 15 integrates (manages) these VTM circuits 23 and CC circuits 16 in units of the battery pack 48.

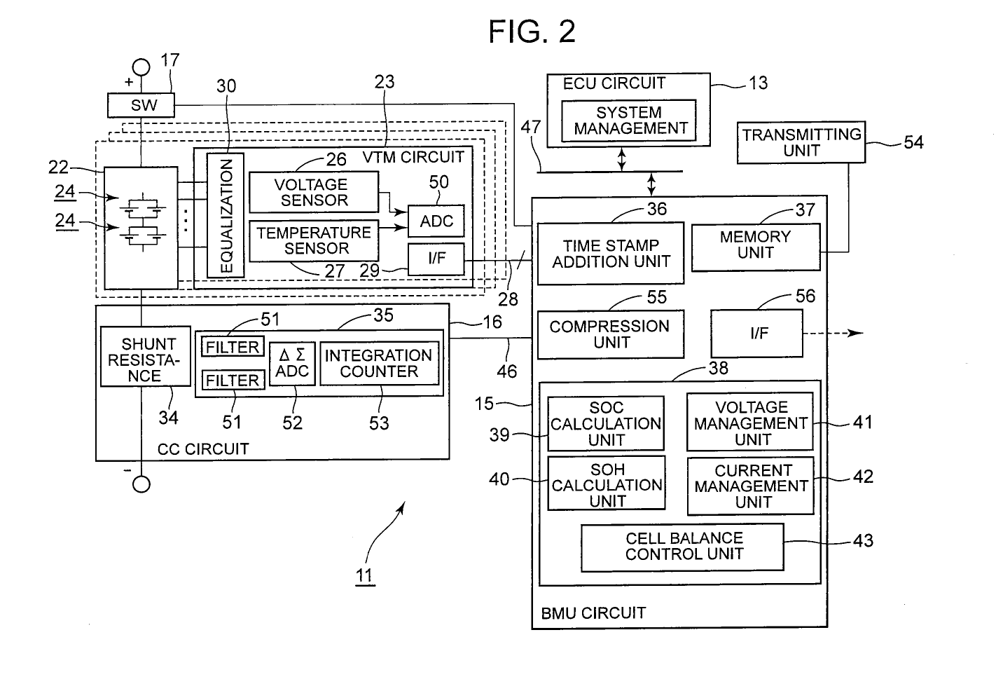

FIG. 2 is a functional block diagram of the secondary battery device 11. One battery module 22 includes a plurality of secondary battery cells 24. One cell 24 is essentially constituted in units of two cells provided in parallel.

The VTM circuit 23 measures the cell voltage and the cell temperature for each cell 24 to monitor the battery module 22. The cell voltage means the voltage between terminals of one cell 24, and is equal to the voltage of a parallel cell unit in the example of the diagram.

The VTM circuit 23 includes a voltage sensor 26 which detects cell voltage of each cell 24, and a temperature sensor 27 which detects cell temperature of each cell 24.

The VTM circuit 23 also includes an A/D converter (ADC) 50 provided at the output side of the voltage sensor 26 and the temperature sensor 27.

The VTM circuit 23 includes an interface unit (I/F) 29, which transmits the digital data of cell voltage and the digital data of cell temperature to the BMU circuit 15 via a signal line 28, and an equalization circuit 30 for equalizing the voltage of each cell 24.

The interface unit 29 outputs the cell voltages and cell temperatures of all the cells 24 in the battery module 22, attaching identification numbers of the VTM circuit 23 thereto. The identification numbers mean circuit board numbers 1, 2 and 3, for example.

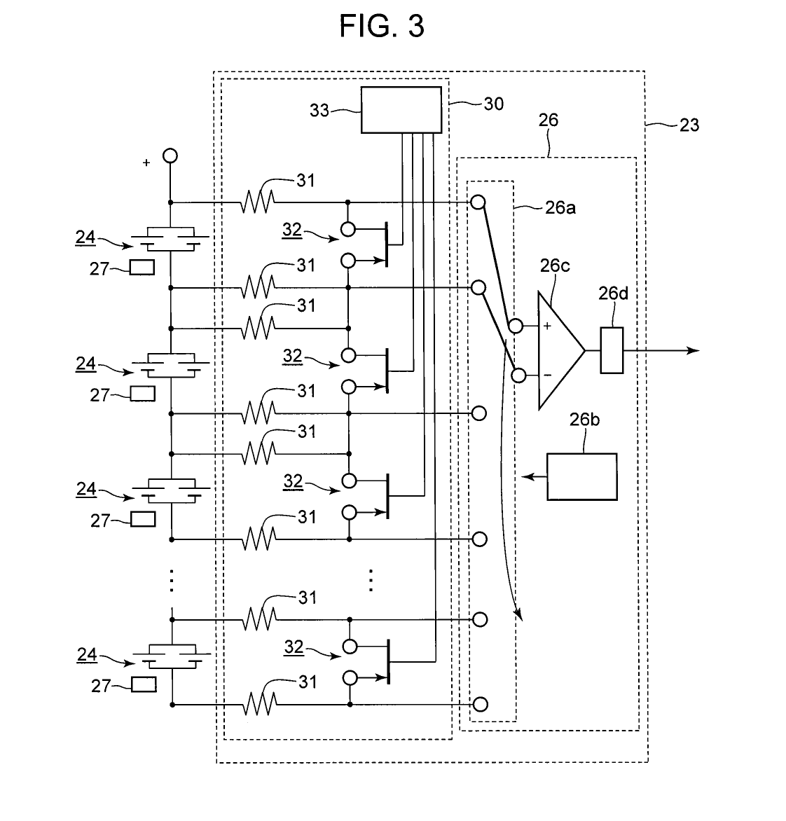

FIG. 3 is a diagram illustrating an example of a configuration of the equalization circuit 30, the voltage sensor 26 and the plurality of temperature sensors 27.

The respective cells 24 are provided in series vertically at the left hand side of the diagram. Respective voltages are supplied to the equalization circuit 30 and the voltage sensor 26 from the both ends of each cell 24 via respective resistances 31 for discharge.

The equalization circuit 30 selects the cells 24 having relatively high cell voltages among these cells 24 individually, for allowing the selected cells 24 to discharge intentionally. This equalization circuit 30 includes the plurality of resistances 31. Each resistance 31 has one end connected to the positive or negative terminal of the cell 24 and the other end connected to a switching element 32.

The equalization circuit 30 includes the plurality of switching elements 32, each switching element 32 opening or closing a path between the other ends of the two resistances 31, and a switch control unit 33 which turns on or off for opening or closing of these switching elements 32 individually.

The voltage sensor 26 is connected at the latter stage of the equalization circuit 30. The voltage sensor 26 is connected to each other end of the plurality of resistances 31 to measure the voltage between the terminals of each resistance 31.

The voltage sensor 26 includes a multiplexer 26a which selects any two of a plurality of cell voltage terminals, and a sequencer 26b which controls a switching timing of the multiplexer 26a.

The sequencer 26b may output a switching signal in conjunction with the switch control unit 33 of the equalization circuit 30.

The voltage sensor 26 also includes an amplifier 26c which amplifies a difference of the two cell voltages selected by the multiplexer 26a, and an A/D converter 26d which converts an analog output of the amplifier 26c into a digital output.

In addition, the temperature sensors 27 are arranged near the cells 24 to detect the cell temperatures in contact or non-contact with the cells 24.

The CC circuit 16 of FIG. 2 measures voltage in units of the battery module 22. The CC circuit includes a shunt resistance 34 (a resistor) connected to the battery module 22 in series, and a current sensor 35.

The current sensor 35 takes in a value of the electric current flowing through the shunt resistance 34 from an electric potential difference which occurs at the both ends of the shunt resistance 34. The current sensor 35 performs time integration of the current value, and equalizes the integral value by integral time.

The shunt resistance 34 has a resistance of hundreds of μΩ. The current sensor 35 has two filters 51, a ΔΣ analog-to-digital converter 52 (an A/D converter), and an integration counter 53 (a charge quantity counter).

The ΔΣ analog-to-digital converter 52 has a resolution expressed in a plurality of bits. The ΔΣ analog-to-digital converter 52 converts analog voltage which occurs at the both ends of the shunt resistance 34 into digital voltage.

The current sensor 35 samples an analog current value and outputs a digital current value having the resolution of 12 bits, for example.

A 12-bit A/D conversion enables the CC circuit 16 to output a current value with larger resolution than the related art.

The integration counter 53 generates detection current from digital output voltage. The CC circuit transmits a detected current value to the BMU circuit 15 from a signal line 46. The switch unit 17 is an MEMS (micro electro mechanical systems) switch.

The secondary battery device 11 also includes a time stamp addition unit 36 (time addition unit), a memory unit 37 (a memory) and an operation unit 38.

The time stamp addition unit 36 adds, at the BMU circuit 15 side, time stamps (time information) to the current value according to the CC circuit 16 as well as the cell voltage value and the cell temperature value according to the VTM circuit 23, respectively.

The memory unit 37 stores the current value, the cell voltage value and the cell temperature value, each being associated with the time stamp.

The operation unit 38 calculates a time difference between the cell temperature value and the cell voltage value, or a time difference between the cell temperature value and the current value according to a history of each value stored in the memory unit 37, and determines a degree of deterioration for each cell 24 according to the time difference.

The time stamp addition unit 36 outputs a current value I from the CC circuit 16 by time series t1, t2, - - - , tn, and outputs I1 (t1), I1 (t2), - - - , I1 (tn). N indicates an integral number.

The time stamp addition unit 36 outputs the time series data of a cell voltage V and the time series data of a cell temperature T of each battery module 22.

The memory unit 37 stores all the values from the time stamp addition unit 36. A connection number of stages of the cells 24 is set to k.

The memory unit 37 stores a row of data mutually matched by time t (=t1, t2, - - - , tn) concerning each of k cells 24 from a first battery module 22.

Specifically, the memory unit 37 stores the row of data {current value I1 (t), cell voltages V11 (t), V12 (t), - - - , V1k (t), cell temperatures T11 (t), T12 (t), - - - , T1k (t)}, each data having been associated with time t (=t1, t2, - - - , tn).

The memory unit 37 stores a row of data{current value, cell voltages and cell temperatures}, each data being associated with time t, concerning each of k cells 24 from a second battery module 22.

The memory unit 37 stores a row of data{current value, cell voltages and cell temperatures}, each data being associated with time t, concerning each of k cells 24 from a third battery module 22.

The operation unit 38 identifies a deteriorated cell among the plurality of cells 24 according to a result of estimation operation. The operation unit 38 also predicts the lifetime of the deteriorated cell according to the result of estimation operation.

The operation unit 38 evaluates the existence of deterioration of the battery module 22 for a day by, for example, variation in cell temperatures and variation in cell voltages for a day.

The operation unit 38 determines a deterioration element which affects deterioration of the battery module 22 by a data-mining technique.

As the technique, the operation unit 38 performs a first evaluation operation concerning each of k cells 24 from the first battery module 22 by the row of data mutually matched by time t {cell temperature T1 (t), cell voltage V1 (t)}.

In addition, the operation unit 38 generates a second evaluation function that shows the relationship between cell temperature values and current values. The operation unit 38 performs a second evaluation operation between the cell temperature values and the current values according to {cell temperatures T1 (t), current values I (t)}.

According to the results of the two kinds of evaluations, which are the first and second evaluations, the operation unit 38 identifies the strongest battery deterioration model among a plurality of, for example, two kinds of battery deterioration models which are to be assumed.

The operation unit 38 predicts deterioration of any one of the cells 24 by comparing the boundary lines with numerical values. The operation unit 38 compares the boundary lines in the graphs of temperature, voltage and current with the numerical values acquired by the evaluation results, as described below.

For example, the operation unit 38 predicts that the full charge capacity of the battery module 22 does not return to 100% of the full charge capacity of a brand-new battery module immediately after a full charging. The operation unit 38 evaluates an amount of the shortage in full charge capacity.

The operation unit 38 also includes an SOC (state of charge) calculation unit 39 and an SOH calculation unit 40.

The SOC calculation unit 39 calculates a state of charge SOC for each battery module 22. The SOH calculation unit 40 calculates a state of health SOH (state of health) for each battery module 22.

The operation unit 38 includes a voltage management unit 41 which manages voltage, a current management unit 42 which manages electric current, and a cell balance control unit 43 which controls the equalization circuit 30 of the VTM circuit 23.

The operation unit 38 calculates the state of charge SOC for each battery module 22 at the time when receiving a demand from the ECU circuit 13. The operation unit 38 calculates the state of charge SOC by remaining capacity (Ah)/full charge capacity (Ah). “/” indicates a division operator.

The operation unit 38 calculates the state of health SOH by full charge capacity at the time of deterioration (Ah)/initial full charge capacity (Ah).

The operation unit 38 controls switching at the switch unit 17, thereby transmitting a result of a battery state calculated to the ECU circuit 13 via a bus 47.

Functions of the BMU circuit 15 are performed by a CPU (central processing unit), a ROM (read only memory) and a RAM (random access memory).

The secondary battery device 11 includes hardware components, which processes a data management program, at the BMU circuit 15.

The data management program has an algorithm which identifies a statistical battery deterioration model from the data measured by the VTM circuit 23 and the CC circuit 16, respectively, and which predicts the lifetime.

The ECU circuit 13 for overall monitoring may create indicative data of the results of operation by the operation unit 38. The ECU circuit 13 functions as an electronic controller.

In the secondary battery device 11 having such a configuration, the VTM circuit 23 usually protects a battery from an overcharge, an overdischarge and an overcurrent by measurement of the cell voltage and the electric current flowing through the cells 24.

The VTM circuit 23 monitors in real time whether the measured voltage and the measured current are larger or smaller than respective thresholds.

When one of the thresholds is exceeded, the VTM circuit 23 transmits an alarm signal indicative of binary ON, OFF towards the BMU circuit 15.

When receiving the alarm signal, the BMU circuit 15 counts the number of times of ON within a certain period of time, thereby determining whether each cell 24 is in an abnormal state or not.

The BMU circuit 15 electrically insulates the battery module 22 including the cell 24 in which abnormalities are detected. Alternatively, the BMU circuit 15 performs an exception processing such as the suspension of charge of a battery.

Execution of the insulation or exception processing by the BMU circuit 15 is to prevent the thermal run away or destruction of this battery module 22 that arises by charging the battery module when a prescribed standard temperature is exceeded.

The CC circuit 16 measures electric current, integrates the electric current by a current direction, and corrects errors. The CC circuit 16 transmits the measured data to the BMU circuit 15.

When receiving the data, the BMU circuit 15 estimates the remaining capacity of the battery module 22 in real time. The BMU circuit 15 estimates the capacity by comparing the initial value of the capacity of the battery module 22 measured beforehand in the time of manufacturing of the battery with the measured data.

From the three VTM circuits 23, the measurement values of cell voltage, cell temperature and electric current flowing through the cells 24 of the corresponding plurality of cells 24 are input into the BMU circuit 15.

The BMU circuit 15 attaches a time stamp to each measurement value, and then accumulates them in the memory unit 37. The data of cell voltage, cell temperature and current values are synchronized and accumulated with the data of cell voltage, cell temperature and current values having been synchronized with each other. The cell voltage and cell temperature from the VTM circuit 23 are collected in the BMU circuit 15.

The BMU circuit 15 calculates impedance from the cell voltage and current values with the time stamp processing every 60 ms per second, for example. Then the BMU circuit 15 monitors a state of load onto the motor 10. The battery module 22 is protected from an overcharge, an overdischarge and an overcurrent.

The BMU circuit 15 determines whether the cell voltage of the cell 24 decreases or not. When any value is out of a normal range, the BMU circuit 15 issues a command to the VTM circuit 23. The VTM circuit 23 selectively charges or discharges the cell 24 according to the equalization circuit 30.

The BMU circuit 15 calculates a characteristic of the capacity of the secondary battery device 11. The BMU circuit 15 detects a discharge voltage V and an amount of charges and discharges A from the central value of the cell voltage and current values according to the memory unit 37.

The BMU circuit 15 adds an integrated value of the amount of charges and discharges A to a value calculated last time. Alternatively, the BMU circuit 15 subtracts the value of the amount of charges and discharges A from the last value.

The BMU circuit 15 may use cell voltage and current values on average of a predetermined number of pieces for detection.

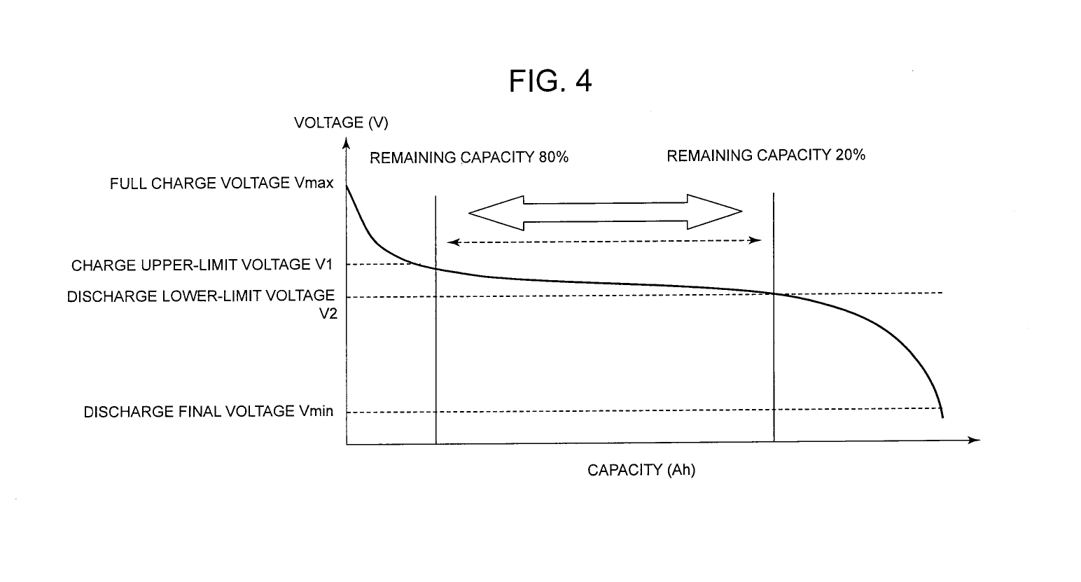

FIG. 4 is a diagram illustrating an example of a discharge characteristic. The diagram illustrates an example of transition for a day of the change in the capacity of the battery module 22.

Vmax indicates a full charge voltage of the battery module 22. Vmin indicates a discharge final voltage. V1 indicates a charge upper limit voltage. V2 indicates a discharge lower limit voltage.

The operation unit 38 monitors each battery module 22 so that the capacity thereof is within 20 to 80% of the full charge capacity of a brand-new battery module.

The operation unit 38 controls charge and discharge so that the voltage comes between the charge upper limit voltage V1 where the voltage V starts to increase rapidly and the discharge lower limit voltage V2 where the voltage V starts to drop quickly.

The following will describe how the BMU circuit 15 estimates a degree of deterioration of a battery.

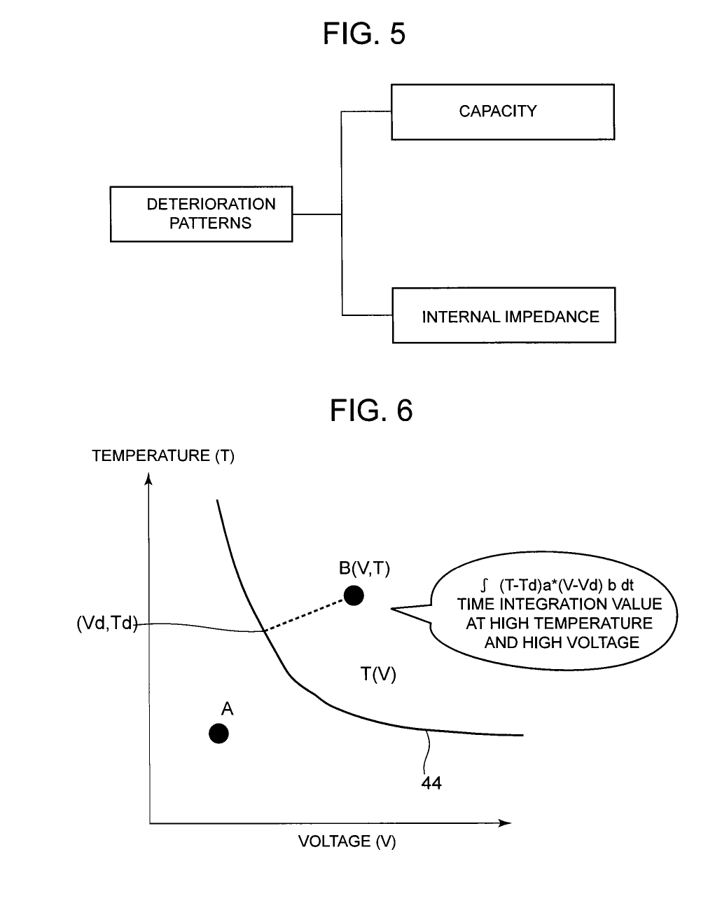

FIG. 5 is a diagram illustrating types of deterioration patterns subject to management by the operation unit 38. Generally, the deterioration patterns of battery chargers are classified into patterns such as (1) the capacity decreases and (2) the internal impedance becomes large.

Which deterioration pattern becomes dominant is determined by the charge of the battery module 22, the retention period of a battery, the combination of temperature, voltage and electric current in the time of discharging, and the time integration value of these values.

The BMU circuit 15 manages the output values of two kinds of evaluation functions generated beforehand, thereby determining which of the two kinds of deterioration patterns is dominant.

For example, the operation unit 38 calculates (voltage value V, temperature T) at a time t and (voltage value Vd, temperature Td) at a time t+td. The operation unit 38 creates a graph by performing the time integration of the amount of temperature changes for the time difference and the amount of voltage changes for the time difference.

FIG. 6 is a diagram illustrating a first evaluation function according to a deterioration pattern when a capacity decreases.

The first evaluation function expressed by a formula in the diagram is one example for determination using a boundary line 44 expressed by the combination of temperature and voltage, and a time integration value of a difference between a point on the boundary line 44 and an arbitrary point.

The operation unit 38 defines a degree of deterioration according to the time integration values of duration during which the combination of the time of high temperature and high voltage continues.

Points A and B in the diagram are arbitrary points. Since the point A exists in a field below the boundary line 44 of the combination of temperature and voltage, the operation unit 38 determines that a battery of which such temperature and voltage are observed is not deteriorated.

On the other hand, since the point B exists in a field above the boundary line 44 of the combination of temperature and voltage, the operation unit 38 determines that a battery of which such temperature and voltage are observed is deteriorated.

The first evaluation function uses cell temperature values, cell voltage values and current values of the memory unit 37 as detection information.

That is to say, the operation unit 38 performs estimation operation of the state of health for each cell 24 in accordance with the battery deterioration model which estimates an intertemporal degree of deterioration of the cells 24 based on the cell temperature values, the cell voltage values and the current values.

The degree of deterioration in a state (T, V) at a certain time can be calculated by multiplying the difference (T−Td, V−Vd) between (T,V) and a point (Vd, Td) where the distance between the point B and the boundary line 44 is the shortest by prescribed multipliers (a, b).

Accordingly, the degree of deterioration in a certain period of time is expressed by the following formula in FIG. 6: ∫(T−Td)a*(V−Vd)b dt.

This formula is used as the first evaluation function.

A and b are herein numbers which are determined beforehand. “*” indicates multiplication. ∫( )dt indicates that the function in ( ) is integrated by time t (the following examples are also the same).

The operation unit 38 uses the first evaluation function that defines each of the cell temperature value and the cell voltage value as an element of deterioration of capacity.

Since deterioration of a battery advances due to temperature, the secondary battery device 11 may generate, specifying a certain temperature as an axis, the relationship between the voltage and the electric current at the certain temperature.

For example, the operation unit 38 calculates (current value I, temperature T) at the time t and (current value Id, temperature Td) at the time t+td. The operation unit 38 creates a graph by performing the time integration of the amount of temperature changes for the time difference and the amount of voltage changes for the time difference.

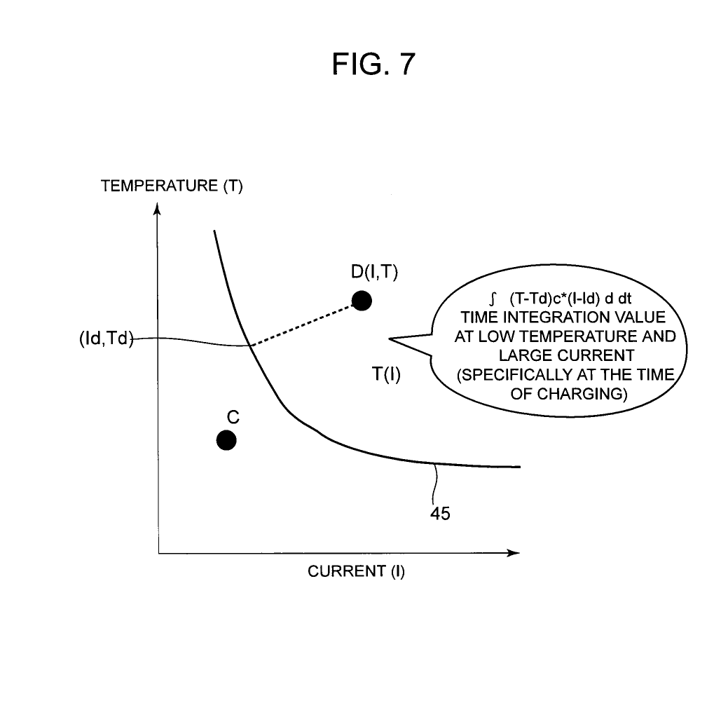

FIG. 7 is a diagram illustrating a second evaluation function according to a deterioration pattern when the internal impedance increases.

The second evaluation function expressed by a formula in FIG. 7 is one example for determination using a boundary line 45 of the combination of temperature and electric current, and a time integration value of a difference between a point on the boundary line 45 and an arbitrary point.

The operation unit 38 defines a degree of deterioration according to the time integration values of duration during which the combination of the time of low temperature and large current continues.

Since point C exists in a field below the boundary line 45 of the combination of temperature and electric current, the operation unit 38 determines that a battery of which such temperature and electric current are observed is not deteriorated.

On the other hand, since point D exists in a field above the boundary line 45 of the combination of temperature and electric current, the operation unit 38 determines that a battery of which such temperature and electric current are observed is deteriorated.

That is to say, the operation unit 38 uses the second evaluation function that defines each of the cell temperature value and the current value as an element of deterioration of the cells 24.

The degree of deterioration in a state (T, I) at a certain time can be calculated by multiplying the difference (T−Td, I−Id) between (T, I) and the point (Td, Id) where the distance between the point D and the boundary line 45 is the shortest by prescribed multipliers (c, d).

Accordingly, the degree of deterioration in a certain period of time is expressed by the following formula in FIG. 7: ∫(T−Td)c*(I−Id)d dt.

This formula is used as the second evaluation function. C and d are herein numbers which are determined beforehand.

The battery capacity of the battery module 22 is measurable with sufficient accuracy by the secondary battery device 11 regardless of the accumulation of errors. The secondary battery device 11 can measure the degree of deterioration of the capacity of the battery module 22 with sufficient accuracy.

The secondary battery device 11 can perform a function to monitor and control each state of charge and discharge, which the secondary battery device 11 naturally has.

In addition, while measuring in real time the amount used by synchronous measurement of voltage and temperature, the secondary battery device 11 becomes possible that the secondary battery device 11 identifies and predicts a battery deterioration model by the statistical procedure of the measured data.

The following will describe effects due to identification and prediction of a deterioration model of a battery.

### (1) Increase in Efficiency of Maintenance During Use of Battery a Secondary Battery Device According to the Related Art Cannot Grasp the Actual States of Health of Battery Modules During Use of the Secondary Battery Device.

The charging and discharging characteristics of the battery modules dramatically change, by prolonged use, from the characteristics at the time of the early stages of manufacturing. Due to this change, the secondary battery device according to the related art cannot measure the remaining capacities of the battery modules by a method of measurement using a coulomb counter.

For this reason, in a case of an electric motorcar which carries a battery, for example, a user cannot know how many kilometers the electric motor will be able to run, unlike a case of a gasoline car.

Accordingly, there has been a problem that a vehicle cannot continue to run due to shortage of the remaining capacity of the battery before arriving at a power-source station.

According to the secondary battery device of the present embodiment, the secondary battery device 11 achieves to grasp the state of health of the battery module 22 in use with higher accuracy.

The secondary battery device 11 enables a user to charge at a station at an appropriate time, without falling into an unexpected shortage of the remaining capacity.

The secondary battery device 11 also achieves to identify the cells 24 which have been resulted in a prescribed state of health, and replace the cells 24 at the time of maintenance.

The secondary battery device according to the related art has not been conventionally economical such that cells still available enough may have been discarded since all the battery modules have been replaced after use for a certain period of time regardless of the actual states of health of the cells.

According to the secondary battery device 11, the secondary battery device 11 becomes convenient to take out and only the cells 24 which are deteriorated are more replaceable.

### (2) Authorization of Residual Value at the Time of Reuse of Battery

Even when the plurality of secondary battery devices are used for the same period of time, the states of health of battery modules widely varies depending on the utilization patterns of the battery modules among the plurality of secondary battery devices.

Therefore, in the related art, there has been a problem that the secondary battery device according to the related art has difficulty of authorizing the residual values of the battery modules.

According to the secondary battery device of the embodiment, the secondary battery device 11 achieves to authorize, with higher accuracy, the residual value at the time of reuse of the battery module 22 after use because the state of health of the battery module 22 after long term use can be grasped.

The secondary battery device 11 achieves to deduct from the purchase price, as a credit, the equivalent of the residual value that the battery module 22 has after use for a certain period of time, temporally retroactive to the time of purchasing of the secondary battery device 11. The economic burden when purchasing a battery is reducible by deducting the equivalent of the residual value after use.

The reduction of economic burden is operative to expect effects to dissolve the problem of initial investment and realize a more rapid progress in a system, such as a car, in which the expensive battery modules 22 having large capacities are used.

Generally, batteries deteriorate with prolonged use of battery modules, causing the full charge capacities to decrease.

In the secondary battery devices according to the related art, the measured capacity is not right because the BMU circuit estimates the capacity using the initial value of the full charge capacity at the time of manufacturing of batteries. The secondary battery devices according to the related art is not operable to identify the states of health of the battery modules with high accuracy.

In the secondary battery devices according to the related art, the information on the voltage and temperature that the VTM circuit has measured and their measuring time is not recorded or saved.

In addition, the voltage and temperature measured by the VTM circuit and the measured data of the integrated current amount measured by the CC circuit are not synchronized.

The secondary battery devices according to the related art cannot measure the impedance of battery modules and cells. The secondary battery devices according to the related art cannot correctly measure the remaining capacities of the batteries.

On the other hand, the secondary battery device 11 enables the measurement of the capacities of the battery modules 22 with sufficient accuracy even when the errors have arisen in the actual full charge capacities due to deterioration of the battery modules 22.

According to the secondary battery device 11, the lifetime of the battery modules 22 can be predicted.

According to the secondary battery device 11, cell voltages can be equalized correctly because each cell voltage is correctly measurable.

The operation of the vehicle 49 includes the rotation of the motor 10 with high voltage at high temperature or the flowing of large current through the motor 10 at low temperature. High voltage at high temperature and large current at low temperature cause remarkable deterioration in the battery modules 22.

According to the secondary battery device and the battery capacity estimation system of the present embodiment, the device and the system is operative to alert a user that the state of the battery module is approaching a state of deterioration.

The secondary battery device and the battery capacity estimation system of the present embodiment, implementation of a fail-safe mechanism on the vehicle 49 becomes available so that the battery modules 22 are not be used in afield in which the battery modules 22 are deteriorated.

### (Modification)

In FIG. 2, the quantity of the data of voltage and temperature which are accumulated in the BMU circuit 15 maybe huge. The secondary battery device 11 may include a transmitting unit 54 which transmits the measurement history information stored in the memory unit 37 to an external network of the vehicle 49.

The transmitting unit 54 adds, for example, an internet protocol address (a destination address) to a packet including the current value, cell voltage value and cell temperature value, each having a time stamp, and transmits them.

The secondary battery device 11 may include a compression unit 55. The compression unit 55 compresses the information stored in the memory unit 37. The compression unit 55 compresses the current value, cell voltage value and cell temperature value, each value having a time stamp.

The secondary battery device 11 may include an interface unit 56.

The interface unit 56 sends the measurement history information of the memory unit 37 or the measurement history information acquired by being compressed by the compression unit 55 to an external storage.

The external storage means a flash memory, a magnetic disk or an optical disk or the like.

According to the embodiment described above, the time stamp addition unit 36 is provided in the BMU circuit 15. However, the time stamp addition unit 36 or a circuitry which adds time stamps may be provided at the side of the VTM circuit 23 and the CC circuit 16.

The time stamp addition unit 36 may be provided independently to the BMU circuit 15, the VTM circuit 23 and the like.

According to the embodiment described above, the operation unit 38 uses both the first evaluation function and the second evaluation function. However, the operation unit 38 may execute a program for determination using the first evaluation function only.

The operation unit 38 may perform estimation operation of the state of health for each cell according to the time difference between a cell voltage value and a cell temperature value.

According to the embodiment described above, the VTM circuits 23 are provided at each battery module 22. One CC circuit 16 and one BMU circuit 15 are provided at the secondary battery device 11. However, these configurations can be modified in various manners.

Cell units which constitute the cells 24 may be three in parallel, for example, instead of two. The temperatures are expressed on the Celsius or Fahrenheit scale.

Note that the present invention is not limited to the embodiments described above and can be embodied in a practical phase by modifying the constituent elements without departing from the spirit and scope of the invention.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. A secondary battery device comprising:
a battery module including a plurality of secondary battery cells;
a battery monitoring circuit configured to measure a cell voltage value and a cell temperature value of each of the cells of the battery module;
a current measurement circuit configured to measure a current value flowing through the battery module in timing substantially identical to measurement timing by the battery monitoring circuit;
a time addition unit configured to add time information to the current value, the cell voltage value and the cell temperature value, respectively;
a memory configured to store the current value, the cell voltage value and the cell temperature value, each value being associated with the time information; and
an operation unit configured to calculate a time difference between the cell temperature value and the cell voltage value, or a time difference between the cell temperature value and the current value stored in the memory, the operation unit determining a degree of deterioration for each of the cells according to the time difference.

2. The secondary battery device of claim 1, wherein
the operation unit configured to perform estimation operation of a state of health for each of the cells in accordance with a battery deterioration model that estimates an intertemporal degree of deterioration of the cell based on the cell temperature values, the cell voltage values and the current values.

3. The secondary battery device of claim 2, wherein
the operation unit configured to use a first evaluation function that defines each of the cell temperature values and the cell voltage values as an element of deterioration of the cells.

4. The secondary battery device of claim 2, wherein
the operation unit configured to use a second evaluation function that defines each of the cell temperature values and the current values as an element of deterioration of the cells.

5. The secondary battery device of claim 2, wherein
the operation unit configured to identify a deteriorated cell among the cells according to a result of the estimation operation.

6. The secondary battery device of claim 2, wherein
the operation unit configured to predict lifetimes of the cells according to a result of the estimation operation.

7. The secondary battery device of claim 1, further comprising:
an equalization circuit configured to equalize each cell voltage.

8. The secondary battery device of claim 1, further comprising:
a battery management unit configured to estimate a capacity of the battery module according to measurement history information including the current value, the cell voltage value and the cell temperature value.

9. The secondary battery device of claim 1, further comprising:
a compression unit configured to compress the current value, the cell voltage value and the cell temperature value stored in the memory unit.

10. The secondary battery device of claim 1, further comprising:
a transmission unit configured to add a destination address to data including the current value, the cell voltage value and the cell temperature value stored in the memory unit.

11. The secondary battery device of claim 1, wherein
the current measurement circuit comprises:
a resistor connected to the battery module in series;
an A/D converter configured to have a resolution expressed in a plurality of bits, the A/D converter converting analog voltage between both ends of the resistor into digital voltage; and
a charge quantity counter configured to generate detection current from an output voltage of the A/D converter, and integrate the detection current.

12. The secondary battery device of claim 1, wherein
the battery monitoring circuit is provided at each battery module.

13. The secondary battery device comprising:
a battery module including a plurality of secondary battery cells;
a battery monitoring circuit configured to measure a cell voltage value and a cell temperature value of each of the cells of the battery module;
a time addition unit configured to add time information to the cell voltage value and the cell temperature value, respectively;
a memory configured to store the cell voltage value and the cell temperature value, each value being associated with the time information; and
an operation unit configured to calculate a time difference between the cell temperature value and the cell voltage value stored in the memory, and determine a degree of deterioration for each of the cells according to the time difference.

14. The secondary battery device of claim 13, wherein
the operation unit configured to perform estimation operation of a state of health for each of the cells in accordance with a battery deterioration model that estimates an intertemporal degree of deterioration of the cell based on the cell temperature value and the cell voltage value.

15. The secondary battery device of claim 13, further comprising:
a battery management unit configured to estimate a capacity of the battery module according to measurement history information including the cell voltage value and the cell temperature value.

16. A battery capacity estimation system comprising:
a motor;
a plurality of battery modules supplying electric power to the motor, each including a plurality of secondary battery cells, the plurality of battery modules being connected in series;
a battery monitoring circuit configured to measure a cell voltage value and a cell temperature value of each of the cells for each of the battery modules;
a current measurement circuit configured to measure a current value flowing through the battery module in timing substantially identical to measurement timing by the battery monitoring circuit;
a time addition unit configured to add time information to the current value, the cell voltage value and the cell temperature value, respectively;
a memory configured to store the current value, the cell voltage value and the cell temperature value, each value being associated with the time information;
an operation unit configured to calculate a time difference between the cell temperature value and the cell voltage value, or a time difference between the cell temperature value and the current value stored in the memory, the operation unit determining a degree of deterioration for each of the cells according to the time difference; and
a battery management unit configured to estimate a capacity of the battery module according to measurement history information including the current value, the cell voltage value and the cell temperature value.

17. The battery capacity estimation system of claim 16, wherein
the operation unit configured to perform estimation operation of a state of health for each of the cells in accordance with a battery deterioration model that estimates an intertemporal degree of deterioration of the cell based on the cell temperature value, the cell voltage value and the current value.

18. The battery capacity estimation system of claim 17, wherein
the operation unit configured to use a first evaluation function that defines each of the cell temperature value and the cell voltage value as an element of deterioration of the cells.

19. The battery capacity estimation system of claim 17, wherein
the operation unit configured to use a second evaluation function that defines each of the cell temperature value and the current value as an element of deterioration of the cells.

20. The battery capacity estimation system of claim 16, further comprising:
an electronic controller configured to create indicative data of a result of operation by the operation unit.
